(19) United States
(12) Patent Application Publication
(10) Pub. No.: US 2016/0112299 A1
(43) Pub. Date: Apr. 21, 2016

(54) CONFIGURING FORWARDING INFORMATION

(71) Applicant: HANGZHOU H3C TECHNOLOGIES CO., LTD., Hangzhou, Zhejiang (CN)

(72) Inventor: Jie LI, Beijing (LI)

(73) Assignee: HANGZHOU H3C TECHNOLOGIES CO., LTD., Hangzhou City (CN)

(21) Appl. No.: 14/888,655

(22) PCT Filed: May 7, 2014
(86) PCT No.: PCT/CN2014/076922

§ 371 Date: Nov. 2, 2015

(30) Foreign Application Priority Data
May 7, 2013 (CN) 201310167065.0

(51) Int. Cl. H04L 12/733; H04L 12/707; H04L 12/801; H04L 12/803

(52) U.S. Cl. CPC H04L 45/122; H04L 47/125; H04L 45/24; H04L 47/17

(57) ABSTRACT

Based on an example, a network apparatus may calculate N equal-cost multi paths to a destination address; sort the N equal-cost multi paths into an order to obtain a sorted result; the sorted result specifying an order from a first ECMP to an Nth ECMP; populate an ECMP table with ECMP entries, each ECMP entry comprising forwarding information associated with a respective ECMP; wherein the ECMP table comprises M entries, wherein M is greater than N, and wherein the ECMP table is populated with ECMP entries according to the order of equal-cost multi paths in the sorted result, and wherein the order is treated in a circular manner such that the N+1th ECMP table entry is populated with forwarding information associated with the first table entry and wherein M=2ⁿ, N≧2, N, M and n are natural numbers.

### BACKGROUND

Equal cost multi path (ECMP) is a routing technique for routing packets along equal-cost multiple paths. When forwarding a packet, a network apparatus may determine one of the equal-cost multi paths for routing.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for configuring forwarding information based on an example of the present disclosure;

FIG. 2 is a flowchart illustrating a method for configuring forwarding information based on another example of the present disclosure;

FIG. 3 is a flowchart illustrating a method for configuring forwarding information based on still another example of the present disclosure;

FIG. 4 is a schematic diagram illustrating a network based on an example of the present disclosure;

FIG. 5 is a flowchart illustrating a method for configuring forwarding information based on the network scenario of FIG. 1;

FIG. 6 is a schematic diagram illustrating an apparatus for configuring forwarding information based on an example of the present disclosure;

FIG. 7 is a schematic diagram illustrating an apparatus for configuring forwarding information based on another example of the present disclosure; and

FIG. 8 is a schematic diagram illustrating an apparatus for configuring forwarding information based on still another example of the present disclosure.

### DETAILED DESCRIPTION

Hereinafter, the present disclosure is described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

### Entries

The present disclosure proposes that where an apparatus has an equal-cost multi path (ECMP) table having a maximum of M entries, but there are only N equal-cost multi paths, M is greater than N, the apparatus can store forwarding information in ECMP entries after the Nth ECMP entry by sorting the equal-cost multi paths into an order, and considering the ECMP after the Nth ECMP to be the first ECMP. In this way, in contrast to a conventional approach, all of the table entries may be used.

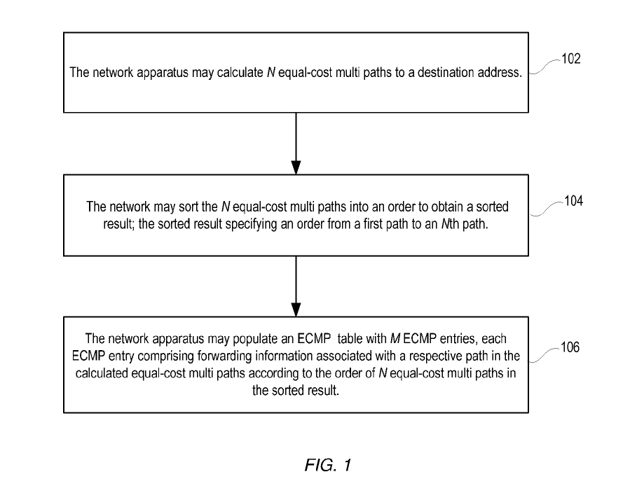

FIG. 1 is a flowchart illustrating a method for configuring forwarding information of an ECMP table based on an example of the present disclosure. This method may be performed by a network apparatus, such as a switch or a router, which performs equal-cost path load balancing. The entity which executes the method is not restricted in the present disclosure. As shown in FIG. 1, the method includes the following.

At block 102, the network apparatus may calculate N equal-cost multi paths to a destination address.

At block 104, the network may sort the N equal-cost multi paths into an order to obtain a sorted result; the sorted result specifying an order from a first path to an Nth path. Any appropriate method of sorting the equal-cost multi paths into an order may be used. In one example the sorting may be by the IP address of the first hop or MAC address of the first hop.

At block 106, the network apparatus may populate an ECMP table with M ECMP entries, each ECMP entry comprising forwarding information associated with a respective path in the calculated equal-cost multi paths according to the order of equal-cost multi paths in the sorted result; wherein M is greater than N and equals to the maximum number of entries in the ECMP table, and wherein the order is treated in a circular manner such that the N+1th ECMP table entry is populated with forwarding information associated with the first table entry, and wherein M=2ⁿ, N≧2, N, M and n are natural numbers.

As the maximum number of ECMP table entries M is greater than the number of equal-cost multi paths N, the order of equal-cost multi paths may be treated in a “circular manner”. According to the “circular manner” the ECMP after the Nth ECMP is considered to be the first ECMP. So for example if N of the number of ECMP paths is 3, and M the maximum number of entries in the ECMP table is 4; then if the order of ECMP paths is path 1, path 2, path 3; then the order of entries in the ECMP table is path 1, path 2, path 3, path 1. In other words the order is cycled in a circular manner.

The forwarding information in the ECMP entry is not restricted in the present disclosure. The forwarding information in the ECMP entry may at least include: address of next-hop (e.g., IP address or MAC address of the next-hop), virtual local area network (VLAN) ID and information of output port. An index the ECMP entry may be a serial number.

For example, when the network apparatus calculate N equal-cost multi paths to the same destination address, the network apparatus may sort the N equal-cost multi paths based on IP addresses, or MAC addresses, or VLAN ID of next-hops on each of the equal-cost multi paths. Suppose that the N equal-cost multi paths are sorted as follows based on IP addresses of next hops in an order: path 1, path 2, path 3 . . . and path N. Since M>N, there may be two situations: The maximum number M of the ECMP entries is an integer multiple of the number N of the equal-cost multi paths or the maximum number M of the ECMP entries is not an integer multiple of the number N of the equal-cost multi paths.

If the maximum number M of the ECMP entries is an integer multiple of the number N of the equal-cost multi paths, the ECMP table may be as shown in table 1.

TABLE 1

| Index | ECMP entry |
|---|---|
| 1 | Forwarding information of the path 1 |
| 2 | Forwarding information of the path 2 |
| 3 | Forwarding information of the path 3 |
| . . . | . . . |
| N | Forwarding information of the path N |
| N + 1 | Forwarding information of the path 1 |
| N + 2 | Forwarding information of the path 2 |
| N + 3 | Forwarding information of the path 3 |
| . . . | . . . |
| 2N | Forwarding information of the path N |
| . . . | . . . |
| M − N + 1 | Forwarding information of the path 1 |
| M − N + 2 | Forwarding information of the path 2 |
| M − N + 3 | Forwarding information of the path 3 |
| . . . | . . . |
| M | Forwarding information of the path N |

It can be seen from table 1 that, the ECMP entries in the ECMP table may include └M/N┘ groups, wherein └ ┘ denotes a round-down operation. In each group of the ECMP entries, the number of the entries and the sequence of the ECMP entries are the same.

If the maximum number M of the ECMP entries is not an integer multiple of the number N of the equal-cost multi paths, the ECMP table may be as shown in table 2.

TABLE 2

| Index | ECMP entry |
|---|---|
| 1 | Forwarding information of path 1 |
| 2 | Forwarding information of path 2 |
| 3 | Forwarding information of path 3 |
| . . . | . . . |
| N | Forwarding information of path N |
| N + 1 | Forwarding information of path 1 |
| N + 2 | Forwarding information of path 2 |
| N + 3 | Forwarding information of path 3 |
| . . . | . . . |
| 2N | Forwarding information of path N |
| . . . | . . . |
| └M/N┘ * N + 1 | Forwarding information of path 1 |
| . . . | . . . |
| M | Forwarding information of path |
| | (M − └M/N┘ * N) |

It can be seen from table 2 that, the M ECMP entries in the ECMP table may include └M/N┘+1 groups. The former └M/N┘ groups (i.e., the first group to the └M/N┘ group), the number of entries and the sequence of the entries are the same. The └M/N┘+1 group includes M−└M/N┘×N ECMP entries conforming to the sorted result. The sequence of the M−└M/N┘×N paths corresponding to the M−└M/N┘×N entries also conforms to the sorted result.

Hereinafter, When the network apparatus receives a packet, the network apparatus may calculate a KEY value based on the packet's header field, calculate a modulus result of the key value modulo the number M of ECMP entries in the forwarding table, select one ECMP entry based on the modulus result, and route the packet based on the selected ECMP entry.

The greater the maximum number of entries in the ECMP table is, the equal-cost multi paths share packets destined for the destination address more uniformly.

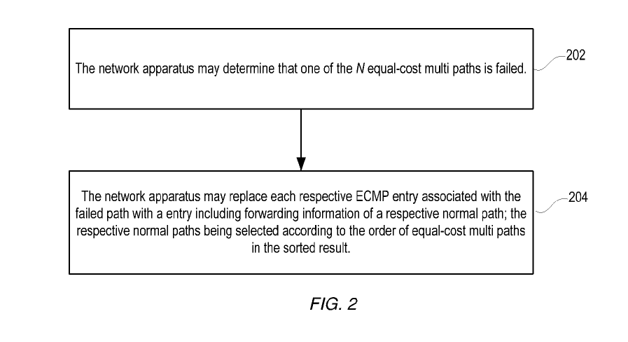

In addition, the above method may further include the following, as shown in FIG. 2.

At block 202, the network apparatus may determine that one of the N equal-cost multi paths is failed.

The remaining equal-cost multi paths are normal. Each failed path may associate with one or a plurality of ECMP entries in the ECMP table.

At block 204, the network apparatus may replace each respective ECMP entry associated with the failed path with a entry including forwarding information of a respective normal path; the respective normal paths being selected according to the order of equal-cost multi paths in the sorted result.

For an example, the order of entries in an ECMP table is path 1, path 2, path 3, path 4. When the path 4 is failed, the network apparatus may perform the blocks 202 to 204 to select path1 based on a sorted result of the path 1, the path 2, the path 3, the path 4. The forwarding information of the ECMP entry associated with the path 4 is replaced with the forwarding information of the path1. Then, the order of entries in an ECMP table is path 1, path 2, path 3, path 1.

Referring the ECMP table shown in table 1 again for an example, the number of the forwarding entries associated with the path 4 is M/N. When the path 4 is failed, the network apparatus may perform the blocks 202 to 204 to select one path based on the sorted result from the path 1, the path 2, the path 3, the path 5, the path 6 . . . and the path N. The forwarding information of respective ECMP entry associated with the path 4 is replaced with forwarding information of each selected path, until all ECMP entries associated with the path 4 is replaced.

As such, it is ensured that other normal equal-cost multi paths are able to share the traffic which was previously routed via the failed path. For example, when the apparatus select the ECMP entry with index 4, the packet which was previously routed via the path 4 will be routed via the path 1.

Though the number of the equal-cost multi paths is changed, the number of ECMP entries in the ECMP table is still M. Therefore, the network apparatus does not need to change algorithm, and still calculate a modulus result of the key value modulo the number M of ECMP entries in the forwarding table.

Referring the ECMP table shown in table 2 again for an example, When the failed the path is still the path 4, the network apparatus may perform blocks 202 to 204 to select one path based on the sorted result from the path 1, the path 2, the path 3, the path 5, the path 6, . . . , and the path N. The forwarding information of respective ECMP entry associated with the path 4 is replaced with forwarding information of each selected path, until all ECMP entries associated with the path 4 is replaced.

Based on the method provided by the example of the present disclosure, if any one of a plurality of equal-cost equal cost paths to the same destination address is failed, the packet which was previously routed to the destination address via the failed equal cost path is now forwarded to the destination address via a normal equal cost path. Path selection results of packets which are previously routed to the destination address via normal equal cost paths do not change. As such, for an application based on a transmission control protocol (TCP) connection, the equal-cost path selection result does not change. Thus, the application does not need to re-establish the TCP connection, which avoids interrupt of the application and avoids affection to user.

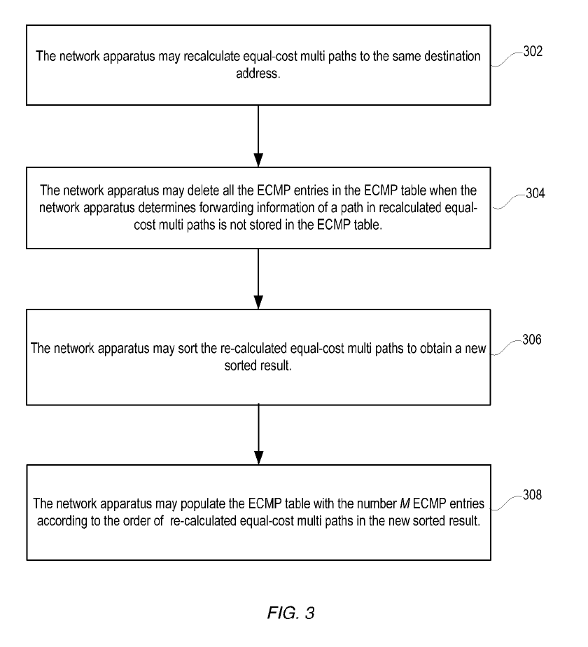

In addition, if the failed path resumes and/or a new path is provided by another device in the network, the method further includes the following processing, as shown in FIG. 3.

At block 302, the network apparatus may recalculate equal-cost multi paths to the same destination address.

At block 304, the network apparatus may delete all the ECMP entries in the ECMP table when the network apparatus determines forwarding information of a path in recalculated equal-cost multi paths is not stored in the ECMP table.

At block 306, the network apparatus may sort the re-calculated equal-cost multi paths to obtain a new sorted result.

At block 308, the network apparatus may populate the ECMP table with the number M ECMP entries according to the order of recalculated equal-cost multi paths in the new sorted result.

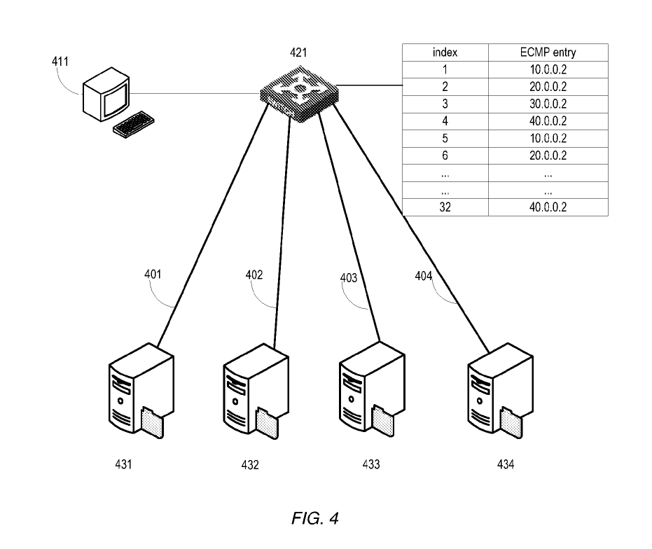

The network as shown in FIG. 4 is taken as an example to describe the method of an example of the present disclosure. In FIG. 4, a PC 411 sends data packets to a service IP address 100.0.0.100 via a switch 421. Four servers 431-434 provide the same service (e.g., webpage search, webpage browse, etc.) and share the service IP address 100.0.0.100. IP addresses of the server 431-434 are respectively 10.0.0.2, 20.0.0.2, 30.0.0.2 and 40.0.0.2.

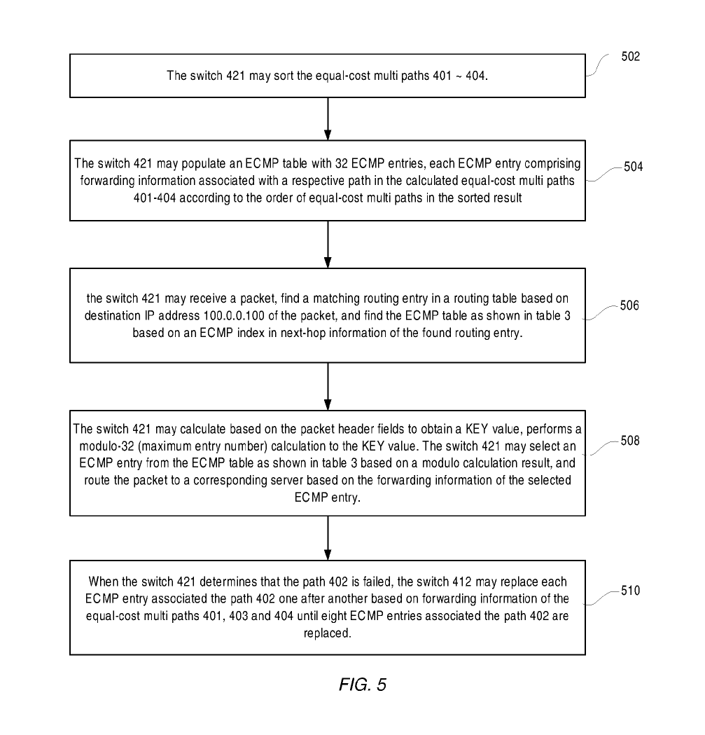

The switch 421 and the four servers 431-434 run Open Switch shortest path first (OSPF) protocol to form an OSPF domain. The switch 421 and the four servers 431-434 are route neighbors, the switch 421 calculates four equal-cost multi paths to the destination address 100.0.0.100. The switch 421 may routes packets to the IP address 100.0.0.100 via the equal-cost multi paths 401-404 to realize load balance via the following blocks, as shown in FIG. 5.

In this example, the forwarding information of each ECMP entry is simplified as IP address of next-hop. It is not restricted that the forwarding information recorded in the ECMP entry includes merely IP address of the next-hop. The servers 431-434 are four next-hops.

At block 502, the switch 421 may sort the equal-cost multi paths 401˜404. It is assumed that the sorted result is: the path 401, the path 402, the path 403 and the path 404. Then block 504 is performed.

At block 504, the switch 421 may populate an ECMP table with 32 ECMP entries, each ECMP entry comprising forwarding information associated with a respective path in the calculated equal-cost multi paths 401-404 according to the order of equal-cost multi paths in the sorted result; wherein the order is treated in a circular manner such that the fifth ECMP table entry is populated with forwarding information associated with the first table entry.

The ECMP entries in the ECMP table of the switch 421 may be shown as table 3.

TABLE 3

| index | ECMP entry |
|---|---|
| 1 | 10.0.0.2 |
| 2 | 20.0.0.2 |
| 3 | 30.0.0.2 |
| 4 | 40.0.0.2 |
| 5 | 10.0.0.2 |
| 6 | 20.0.0.2 |
| 7 | 30.0.0.2 |
| 8 | 40.0.0.2 |
| 9 | 10.0.0.2 |
| 10 | 20.0.0.2 |
| 11 | 30.0.0.2 |
| 12 | 40.0.0.2 |
| 13 | 10.0.0.2 |
| 14 | 20.0.0.2 |
| 15 | 30.0.0.2 |
| 16 | 40.0.0.2 |
| 17 | 10.0.0.2 |
| 18 | 20.0.0.2 |
| 19 | 30.0.0.2 |
| 20 | 40.0.0.2 |
| 21 | 10.0.0.2 |
| 22 | 20.0.0.2 |
| 23 | 30.0.0.2 |
| 24 | 40.0.0.2 |
| 25 | 10.0.0.2 |
| 26 | 20.0.0.2 |
| 27 | 30.0.0.2 |
| 28 | 40.0.0.2 |
| 29 | 10.0.0.2 |
| 30 | 20.0.0.2 |
| 31 | 30.0.0.2 |
| 32 | 40.0.0.2 |

In table 3, since 32 is an integer multiple of 4, the four kinds of forwarding information are uniformly distributed to the 32 ECMP entries. The maximum entry number M of the switch 421 may also be 64 or 1024 or other values of the nth power of 2. The larger the value of M is, the more uniformly the paths are selected.

At block 506, the switch 421 may receive a packet transmitted by the PC 411, may find a matching routing entry in a routing table based on destination IP address 100.0.0.100 of the packet, and may find the ECMP table as shown in table 3 based on an ECMP index in next-hop information of the found routing entry.

At block 508, The switch 421 may calculate based on the packet header fields to obtain a KEY value, and perform a modulo-32 (maximum entry number) calculation to the KEY value, may select an ECMP entry from the ECMP table as shown in table 3 based on a modulo calculation result, and may route the packet to a corresponding server based on the forwarding information of the selected ECMP entry.

For example, when result of modulo calculation is 15, the switch 421 may select the 16^{th} ECMP entry, i.e., an entry with index 16. The modulus calculation result indicates a position of the entry to be selected.

At block 510, when the switch 421 determines that the path 402 is failed, the switch 412 may replace each ECMP entry associated the path 402 one after another based on forwarding information of the equal-cost multi paths 401, 403 and 404 until eight ECMP entries associated the path 402 are replaced.

The ECMP table after the replacement is as shown in table 4.

TABLE 4

| index | ECMP entry |
|---|---|
| 1 | 10.0.0.2 |
| 2 | 10.0.0.2 |
| 3 | 30.0.0.2 |
| 4 | 40.0.0.2 |
| 5 | 10.0.0.2 |
| 6 | 30.0.0.2 |
| 7 | 30.0.0.2 |
| 8 | 40.0.0.2 |
| 9 | 10.0.0.2 |
| 10 | 40.0.0.2 |
| 11 | 30.0.0.2 |
| 12 | 40.0.0.2 |
| 13 | 10.0.0.2 |
| 14 | 10.0.0.2 |
| 15 | 30.0.0.2 |
| 16 | 40.0.0.2 |
| 17 | 10.0.0.2 |
| 18 | 30.0.0.2 |
| 19 | 30.0.0.2 |
| 20 | 40.0.0.2 |
| 21 | 10.0.0.2 |
| 22 | 40.0.0.2 |
| 23 | 30.0.0.2 |
| 24 | 40.0.0.2 |
| 25 | 10.0.0.2 |
| 26 | 10.0.0.2 |
| 27 | 30.0.0.2 |
| 28 | 40.0.0.2 |
| 29 | 10.0.0.2 |
| 30 | 30.0.0.2 |
| 31 | 30.0.0.2 |
| 32 | 40.0.0.2 |

After the route converges, the switch 421 may re-calculate three equal-cost multi paths to the destination address IP 100.0.0.100, which are the path 401, the path 403 and the path 404. The ECMP entries associated with recalculated equal-cost multi paths 401, 403 and 404 have been stored in the ECMP table as shown in table 4. Therefore, the ECMP table as shown in table 4 is remained unchanged.

When the switch 421 receives packets to the destination IP address 100.0.0.100, the switch 421 may route it among the equal-cost multi paths 401, 403 and 404. The procedures are not repeated herein.

At this time, the selection ratio of the paths of the next-hops is =11:11:10. If the switch 421 stores ECMP entries associated with the equal-cost multi paths 401, 403 and 404 in an ECMP table of which the maximum number of ECMP entries is 64, the selection ratio of the next-hop is 22:21:21. Each of the equal-cost multi paths may be selected more uniformly.

Though number of equal-cost multi paths is change to 3, but the number of ECMP entries in the ECMP table as shown in table 4 remains 32, the switch 421 may still performs the modulo-32 calculation to the KEY value, flows on the paths 402 change paths and may be shared by the normal paths 401, 403 and 404, and flows on the paths 401, 403 and 404 do not change paths.

When the switch 421 determines that the path 402 is recovered and routes is converge, the switch 421 may re-calculate to obtain equal-cost multi paths 401˜404 to the destination address 100.0.0.100. The switch 421 may delete all the ECMP entries shown in the table 4 when the switch 421 determines that there is no ECMP entry storing forwarding information of the path 402 in the re-calculated equal-cost multi paths 401˜404. The switch 421 may resort the re-calculated equal-cost multi paths 401˜404 to obtain a new sorted result. Suppose that the new sorted result is: the path 402, the path 404, the path 403 and the path 401. The switch 421 may store ECMP entries based on forwarding information of based on the new sorted result of the equal-cost multi paths 401-404 until the total number of ECMP entries reaches the maximum number 32. At this time, the ECMP entries in the ECMP table of the switch 421 are as shown in table 5.

TABLE 5

| index | ECMP entry |
|---|---|
| 1 | 20.0.0.2 |
| 2 | 40.0.0.2 |
| 3 | 30.0.0.2 |
| 4 | 10.0.0.2 |
| 5 | 20.0.0.2 |
| 6 | 40.0.0.2 |
| 7 | 30.0.0.2 |
| 8 | 10.0.0.2 |
| 9 | 20.0.0.2 |
| 10 | 40.0.0.2 |
| 11 | 30.0.0.2 |
| 12 | 10.0.0.2 |
| 13 | 20.0.0.2 |
| 14 | 40.0.0.2 |
| 15 | 30.0.0.2 |
| 16 | 10.0.0.2 |
| 17 | 20.0.0.2 |
| 18 | 40.0.0.2 |
| 19 | 30.0.0.2 |
| 20 | 10.0.0.2 |
| 21 | 20.0.0.2 |
| 22 | 40.0.0.2 |
| 23 | 30.0.0.2 |
| 24 | 10.0.0.2 |
| 25 | 20.0.0.2 |
| 26 | 40.0.0.2 |
| 27 | 30.0.0.2 |
| 28 | 10.0.0.2 |
| 29 | 20.0.0.2 |
| 30 | 40.0.0.2 |
| 31 | 30.0.0.2 |
| 32 | 10.0.0.2 |

When the switch 421 receives packets to the destination IP address 100.0.0.100, the switch 421 may route the packets among the paths 401-404. The procedure is not repeated herein.

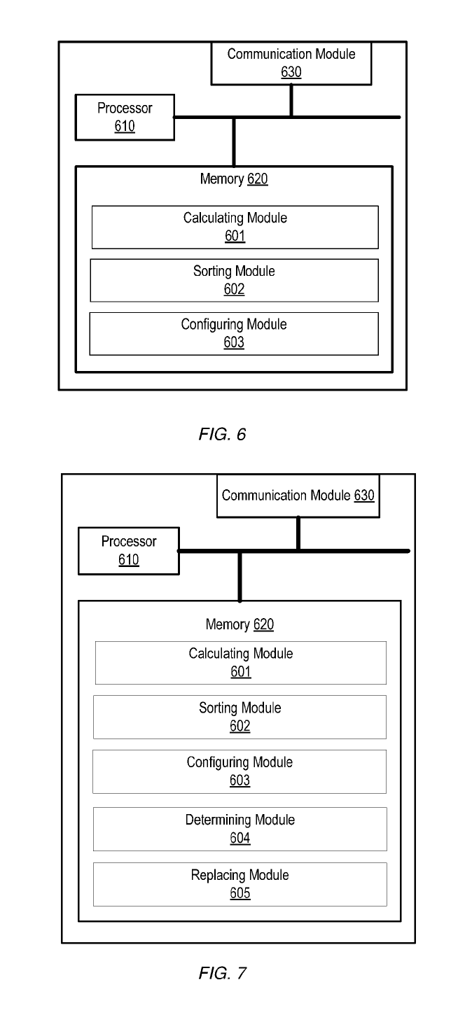

In accordance with the above method example, an example of the present disclosure provides an apparatus for configuring forwarding information. As shown in FIG. 6, the apparatus includes: a processor 610, a memory 620 communicatively connected with the processor 610, and a communication module 630. The communication module 630 may for example include a port such as an Ethernet port to connect to a network. The memory 620 stores one or more program modules executable by the processor 610. The memory 620 may be a non-transitory storage medium such as EPROM, EEPROM, DRAM, flash memory devices, hard disk, optical disk, etc. The one or more program modules include:

A calculating module 601 may calculate N equal-cost multi paths for arriving at a destination address.

A sorting module 602 may sort the N equal-cost multi paths into an order to obtain a sorted result; the sorted result specifying an order from a first ECMP to an Nth ECMP

A configuring module 603 may populate an ECMP table with ECMP entries, each ECMP entry comprising forwarding information associated with a respective ECMP; wherein the ECMP table comprises M entries, wherein M is greater than N, and wherein the ECMP table is populated with ECMP entries according to the order of equal-cost multi paths in the sorted result, and wherein the order is treated in a circular manner such that the N+1th ECMP table entry is populated with forwarding information associated with the first table entry and wherein M=2ⁿ, N≧2, N, M and n are natural numbers.

As shown in FIG. 7, the memory 620 may further include a failure determining module 604 and a replacing module 605.

The failure determining module 604 may determine at least one of the N equal-cost multi paths is failed, and the remaining are normal equal-cost multi paths.

The replacing module 605 may replace each respective ECMP entry associated with the failed path with an entry including forwarding information of a respective normal path; the respective normal paths being selected according to the order of equal-cost multi paths in the sorted result.

If M is an integer multiple of N, the M ECMP entries may be divided into └M/N┘ groups. Each group includes N ECMP entries conforming to the above sorted result, wherein └ ┘ denotes a round-down operation. If M is not an integer multiple of N, the M ECMP entries may be divided into └M/N┘+1 groups. Each group from the first group to the └M/N┘ group includes N ECMP entries conforming to the above sorted result. The └M/N┘+1 group includes M−└M/N┘×N ECMP entries conforming to the above sorted result, wherein └ ┘ denotes a round-down operation.

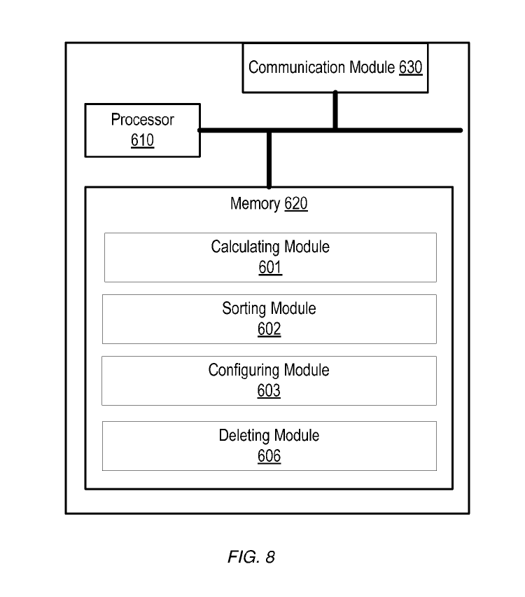

As shown in FIG. 8, the memory 620 may further include a deleting module 606.

The calculating module 601 re-calculates equal-cost multi paths for arriving at the destination address.

The deleting module 606 may delete all of the ECMP entries in the ECMP table in response to determine that forwarding information of a path in the recalculated equal-cost multi paths is not stored in the ECMP table.

The sorting module 602 may sort the re-calculated equal-cost multi paths to obtain a new sorted result.

The configuring module 603 may populate the ECMP table with the number M ECMP entries according to the order of recalculated equal-cost multi paths in the new sorted result.

In view of the above, in various examples of the present disclosure, if one of a plurality of equal-cost multi paths to the same destination address is failed, the packet which was previously routed via the failed path is now routed to the destination address via a normal path. Packet which was previously routed via a normal path is still routed via the normal path.

The above examples may be implemented by hardware, software, firmware, or a combination thereof. For example the various methods, processes and functional modules described herein may be implemented by a processor. Further, the examples disclosed herein may be implemented in the form of a software product. The computer software product is stored in a non-transitory storage medium and comprises a plurality of instructions for making a computer device (which may be a personal computer, a server or a network device, such as a router, switch, access point, etc.) implement the method recited in the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A method for configuring forwarding information, comprising:
calculating N equal-cost multi paths to a destination address;
sorting the N equal-cost multi paths into an order to obtain a sorted result;
the sorted result specifying an order from a first ECMP to an Nth ECMP;
populating an ECMP table with ECMP entries, each ECMP entry comprising forwarding information associated with a respective ECMP;
wherein the ECMP table comprises M entries, wherein M is greater than N, and wherein the ECMP table is populated with ECMP entries according to the order of equal-cost multi paths in the sorted result, and wherein the order is treated in a circular manner such that the N+1th ECMP table entry is populated with forwarding information associated with the first table entry and wherein M=2ⁿ, N≧2, N, M and n are natural numbers.

2. The method of claim 1, further comprising:
determining at least one of the N equal-cost multi paths is failed, and the remaining are normal equal-cost multi paths;
replacing each respective ECMP entry associated with the failed path with an entry including forwarding information of a respective normal path; the respective normal paths being selected according to the order of equal-cost multi paths in the sorted result.

3. The method of claim 1, wherein
if M is an integer multiple of N, the M ECMP entries are divided into └M/N┘ groups; each group comprises N ECMP entries conforming to the sorted result, wherein └ ┘ denotes a round-down operation.

4. The method of claim 1, wherein if M is not an integer multiple of N, the M ECMP entries are divided into └M/N┘+1 groups; each group from the first group to the └M/N┘ group comprises N ECMP entries conforming to the sorted result; the └M/N┘+1 group comprises M−└M/N┘×N ECMP entries conforming to the sorted result, wherein └ ┘ denotes a round-down operation.

5. The method of claim 2, further comprising:
re-calculating equal-cost multi paths to the same destination address;
deleting all of the ECMP entries in the ECMP table in response to determine that forwarding information of a path in the recalculated equal-cost multi paths is not stored in the ECMP table,
sorting the re-calculated equal-cost multi paths to obtain a new sorted result;
populating the ECMP table with the number M ECMP entries according to the order of re-calculated equal-cost multi paths in the new sorted result.

6. An apparatus for configuring forwarding information, comprising:
a processor;
a memory;
wherein one or more program modules are stored in the memory and to be executed by the processor, the one or more program modules comprise:
a calculating module, to calculate N equal-cost multi paths to a destination address;
a sorting module, to sort the N equal-cost multi paths into an order to obtain a sorted result; the sorted result specifying an order from a first ECMP to an Nth ECMP; and
a configuring module, to
populate an ECMP table with ECMP entries, each ECMP entry comprising forwarding information associated with a respective ECMP;
wherein the ECMP table comprises M entries, wherein M is greater than N, and wherein the ECMP table is populated with ECMP entries according to the order of equal-cost multi paths in the sorted result, and wherein the order is treated in a circular manner such that the N+1th ECMP table entry is populated with forwarding information associated with the first table entry and wherein M=2ⁿ, N≧2, N, M and n are natural numbers.

7. The apparatus of claim 6, further comprising:
a failure determining module, to determine at least one of the N equal-cost multi paths is failed, and the remaining are normal equal-cost multi paths; and
a replacing module, to replace each respective ECMP entry associated with the failed path with an entry including forwarding information of a respective normal path; the respective normal paths being selected according to the order of equal-cost multi paths in the sorted result.

8. The apparatus of claim 6, wherein
if M is an integer multiple of N, the M ECMP entries are divided into └M/N┘ groups; each group comprises N ECMP entries conforming to the sorted result, wherein └ ┘ denotes a round-down operation.

9. The apparatus of claim 6, wherein if M is not an integer multiple of N, the M ECMP entries are divided into └M/N┘+1 groups; each group from the first group to the └M/N┘ group comprises N ECMP entries conforming to the sorted result; the └M/N┘+1 group comprises M−└M/N┘×N ECMP entries conforming to the sorted result, wherein └ ┘ denotes a round-down operation.

10. The apparatus of claim 6, further comprising: a deleting module; wherein
the calculating module is further to re-calculate equal-cost multi paths to the same destination address;
the deleting module is to delete deleting all of the ECMP entries in the ECMP table in response to determine that forwarding information of a path in the re-calculated equal-cost multi paths is not stored in the ECMP table;
the sorting module is further to sort the re-calculated equal-cost multi paths to obtain a new sorted result; and
the configuring module is further to populate the ECMP table with the number M ECMP entries according to the order of recalculated equal-cost multi paths in the new sorted result.
